(19) United States
(12) Patent Application Publication
(10) Pub. No.: US 2018/0072481 A1
(43) Pub. Date: Mar. 15, 2018

(54) Multi-Chambered Beverage Container and Mixing Apparatus

(71) Applicant: Barry Boatner, Daytona Beach, FL (US)

(72) Inventor: Barry Boatner, Daytona Beach, FL (US)

(21) Appl. No.: 15/698,127

(22) Filed: Sep. 7, 2017

Related U.S. Application Data
(63) Continuation of application No. 62/393,394, filed on Sep. 12, 2016.

(51) Int. Cl. B65D 81/32; B65D 51/28; B65D 41/02; B65D 25/08

(52) U.S. Cl. CPC B65D 81/3227; B65D 51/2857; B05C 17/00559; B65D 25/087; B65D 41/023

(57) ABSTRACT

A multi-chambered beverage container and mixing apparatus that includes an outer container defined as a host. The host includes a host top, a host lid, a host body, and a host bottom including a plug. It also includes an inner container defined as an upshot, with an upshot handle comprising lateral members, an upshot head, an upshot body and an upshot opening. The upshot is positionable within an enclosed interior of the host body and the upshot opening is configured to matingly engage the plug to form a fluidic seal between the upshot opening and the plug.

### RELATED APPLICATIONS

This application is related to and claims priority to U.S. Provisional Patent Application Ser. No. 62/393,394 titled Bifurcated Beverage Container filed Sep. 12, 2016. The contents of which is incorporated herein in its entirety by reference, except to the extent disclosure therein is inconsistent with disclosure herein.

### FIELD OF THE INVENTION

The present invention relates to multi-chambered beverage containers and methods for mixing contents contained therein.

### BACKGROUND

When consuming alcoholic beverages, many people enjoy the taste of a mixed drink or cocktail. As such, restaurants and bars are typically stocked full of various spirits such as vodka, whiskey, gin and/or tequila, which can be mixed with any number of other beverages such as soda, water or juice.

Unlike beer, which can be bought at virtually any convenience store, there does not currently exist a commercially successful brand of mixed drinks that does not require a user to separately pour and blend the alcoholic and non-alcoholic portions of the beverage together to form a cocktail. Although attempts have been made to provide a pre-mixed cocktail, such attempts have been largely unsuccessful owing to the breakdown of sugar within the beverages causing a poor taste and potential diminishment of the alcoholic content over time.

Furthermore, certain drinks require mixing liquid with granulated powder such as performance drinks, protein drinks, vitamin drinks and the like. However, there does not exist an apparatus for packaging both the granulated powder with the liquid that includes an easy method for combining and drinking them.

Accordingly, the present invention solves this problem by providing a multi-chambered beverage container that is capable of storing a plurality of different liquids or granulated powder within a single container.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a multi-chambered beverage container and mixing apparatus (“apparatus”) including an outer container defined as a host. The host may include a host top, a host lid, a host body, and a host bottom including a plug. It also may include an inner container defined as an upshot, with an upshot handle comprising lateral members, an upshot head, an upshot body and an upshot opening. The upshot may be positionable within an enclosed interior of the host body and the upshot opening may be configured to matingly engage the plug to form a fluidic seal between the upshot opening and the plug.

The apparatus may further include a recess, defined as an upshot placeholder, structured to engage with the upshot head. It may also be structured so that a circumference of interior walls of the upshot body and circumference of the upshot opening are sized to establish a friction fit with a base of the plug. Furthermore, the interior walls of the upshot body proximate the upshot opening may include threading enabled to matingly engage threading on the plug. Additionally, the host lid may be structured to rem oveably engage with an interior of the host top.

The upshot body may be tubular and sized to permit disposal therewithin of at least one of two-ounces of matter and one-ounce of matter. The matter may include at least one of a liquid substance and a granular substance. Furthermore, the upshot handle may include at least one planar surface that is operable as an advertising platform.

In one embodiment the plug may include an O-ring gasket. Furthermore, the upshot opening and a portion of the upshot body may be configured to establish a friction fit with the O-ring gasket.

Another embodiment of the apparatus may include an outer container, defined as a host including a body and a plug. It may also include an inner container, defined as an upshot with an upshot handle, an upshot body comprising a plurality of upshot chambers formed from an upshot divider, and an arcuate upshot opening. The upshot may be located within an enclosed interior of the host body and the arcuate upshot opening may be structured to matingly engage the plug to form a fluidic seal between the upshot opening and the plug.

This embodiment may include the plurality of upshot chambers structured to contain at least one of an ounce of liquid and an ounce of granulated matter. Furthermore, the host lid may be structured to removeably engage with an interior of the host top and the upshot handle may comprise at least one planar surface that is operable as an advertising platform.

In some embodiments the upshot may include at least two upshot chambers of the plurality of upshot chambers whereby the at least two upshot chambers may be differently sized and structured to hold a different amount of matter in each.

In some embodiments the upshot divider may be structured to removably engage a plug notch. Furthermore, upshot body walls may be structured to removably engage a circular recess in a host bottom and the plurality of chambers may be tubular. Additionally, the upshot handle may include opposing ends structured to extend to a nominal distance between them and interior walls of the host. Also, a host lid may further include a recess, defined as an upshot placeholder, structured to engage with an upshot head located on the upshot handle. The upshot head may be structured to removably engage an aperture within the upshot handle.

Another embodiment of the apparatus may include an outer container, defined as a host with a host top, a host lid, a host body, and a host bottom including a plurality of plugs. The apparatus may also include an inner container, defined as an upshot, with an upshot handle, an upshot head, a plurality of upshot necks, a plurality of upshot bodies, and a plurality of upshot openings. The upshot may be positionable within an enclosed interior of the host body and the upshot openings may be structured to matingly engage a plurality of plugs to form fluidic seals therebetween.

### BRIEF DESCRIPTION OF THE DRAWINGS

FIG. 1 is a perspective side view of a multi-chambered beverage container and mixing apparatus according to an embodiment of the present invention.

FIG. 2 is a perspective view of another embodiment of a multi-chambered beverage container and mixing apparatus of the present invention.

FIG. 3 is a partial cross-sectional perspective view of the outer container of the multi-chambered beverage container and mixing apparatus taken through lines 3-3 of FIG. 2.

FIG. 4 is a perspective view of another embodiment of the multi-chambered beverage container and mixing apparatus of the present invention.

FIG. 5 is a perspective view of another embodiment of a multi-chambered beverage container and mixing apparatus of the present invention.

FIG. 6 is an exploded, cross section view of another embodiment of the multi-chambered beverage container and mixing apparatus.

FIG. 7 is a top view of a cross section of the multi-chambered beverage container and mixing apparatus of taken through lines 7-7 of FIG. 6.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a multi-chambered beverage container and mixing apparatus.

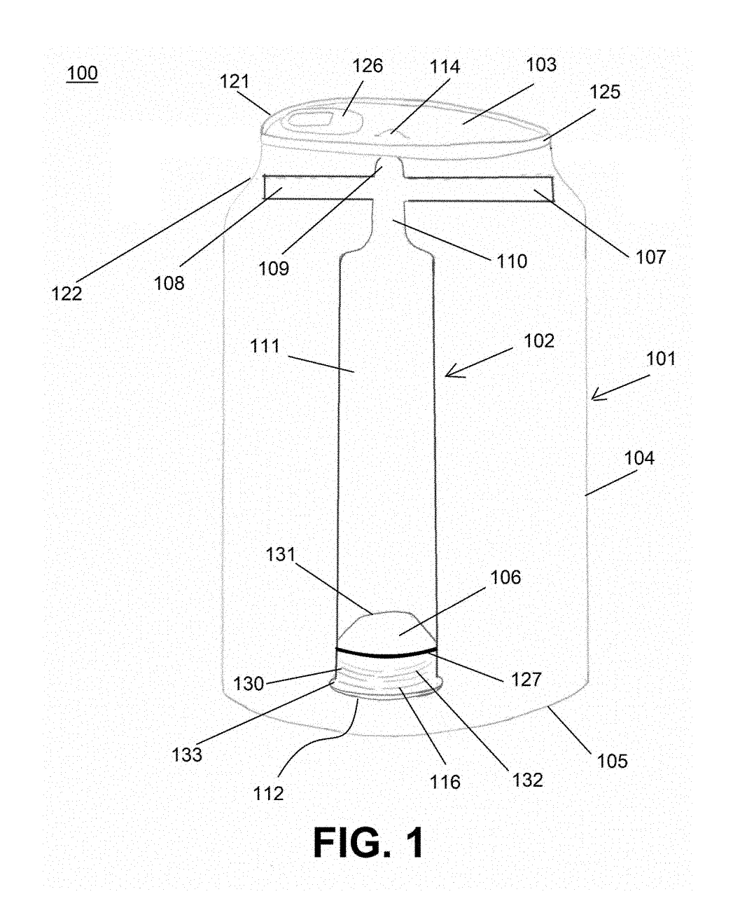

Referring to FIG. 1, the multi-chambered beverage container and mixing apparatus 100 (hereinafter “the apparatus 100”) may include an outer container, defined as a host 101 and an inner container defined as an upshot 102. The host 101 may be any type of beverage container. By way of non-limiting example, the host 101 may be a can, bottle, glass or jar. The host 101 may be manufactured from a variety of different materials including metal, metal alloy, plastic, polymer, glass, wood or wood-based product. The host 101 may include a host lid 103, a host top 121, a host body 104, and a host bottom 105. The host body 104 may be located between the host bottom 105 and the host top 121. In one embodiment, the host 101 may be generally cylindrical in shape but with a host top 121 that has a smaller diameter than the diameter of the host bottom 105. In this embodiment the host 101 may comprise a host taper 122 between one end of the host body 104 and the host top 121. However, it is contemplated that the host 101 may be a true cylinder with a host bottom 105 and a host top 121 of equal diameter.

The host top 121 may be circular in shape and may circumscribe a host opening (not shown) with a diameter equal to the diameter between interior walls of the host top 121. The host opening may be covered by the host lid 103 which may also be circular in shape and may include a diameter equal to the host top 121 interior walls. However, in some embodiments the host lid 103 may be slightly larger than the host opening and may engage with and form a friction fit overtop of exterior walls of the host top 121. In this embodiment, the host top 121 may include a host ridge 125 to facilitate the friction fit between the host top 121 and the host lid 103.

In embodiments where the host lid 103 has a diameter equal to the diameter between interior walls of the host top 121, the host lid 103 may include a pull tab 126 to facilitate gripping and pulling the host lid 103 away from the host top 121. Therefore, the host lid may be removeably engaged with an interior of the host top. The pull tab 126 may be located distally from the focus, or center of the host lid 103. Upon removal of the host lid 103 from the host top 121, the entire host opening may be exposed.

The host lid 103 may include an upshot placeholder 114. The upshot placeholder 114 may be a recess within the structure of the host lid 103. In one embodiment, the upshot placeholder 114 may be located at a center point of the host lid 103. However, in other embodiments, the upshot placeholder 114 may be located elsewhere along the host lid 103. Furthermore, in some embodiments there may be a plurality of upshot placeholders 114 dispersed at different points on the host lid 103. The upshot placeholder 114 may be dimensioned to fittingly engage with a portion of the upshot 102 and may assist with stabilization of the upshot 102.

The upshot 102 itself may be an elongate member positionable within the host body 104. The upshot 102 may include an upshot handle 107, an upshot head 109, an upshot neck 110, an upshot body 111, and an upshot opening 112. The upshot opening 112 may be located at a longitudinally opposite end from the upshot head 109.

The upshot 102 may be structured so that the upshot opening 112 encompasses one end of the upshot body 111. The upshot body 111 may be tubular and may extend from the upshot opening 112 to the upshot neck 110. The upshot neck 110 may be a portion of the upshot 102 that tapers from the upshot body 111 to the upshot handle 107.

The upshot handle 107 may be located between the upshot neck 110 and the upshot head 109. The upshot handle 107 may include lateral members 108 that may extend outward in a generally perpendicular direction relative to the upshot body 111. Furthermore, the upshot handle 107, including the lateral members 108, may consist of at least one planar surface that may be operable as an advenbrtising platform. Additionally, the upshot handle 107 may be structured in a manner to facilitate gripping, twisting, stirring, and/or pulling the upshot 102 out of the host 101. In some embodiments, the upshot handle 107 may be rectangular, pentagonal, polygonal, ring-shaped, or generally shaped as one half of a longitudinally bisected ovum. However, any shape is contemplated to be within the scope herein that facilitates the above motions. For example, the upshot handle 107 may include an undulated and/or knurled surface used to assist with grasping it.

The upshot head 109 may encompass one end of the upshot 102. In some embodiments, the upshot head 109 may extend distally from the upshot handle 107 and may include a rounded surface designed to fittingly engage with the upshot placeholder 114 on the host lid 103. However, other embodiments may include an upshot head 109 with a square or polygonal surface sized to engage a corresponding square or polygonal upshot placeholder 114. In some embodiments, the upshot head 109 may be integrally formed with the upshot handle 107. In other embodiments the upshot head 109 may be a removable stopper structured to removably engage an aperture within the upshot handle 107. In this embodiment, when the upshot head 109 is removed, the exposed aperture may be used to fill the upshot 102 with matter. In any embodiment, the upshot head 109 may extend distally from the upshot handle 107 longitudinally to engage an underside of the host lid 103 at the upshot placeholder 114 to stabilize the upshot 102 within the host body 104.

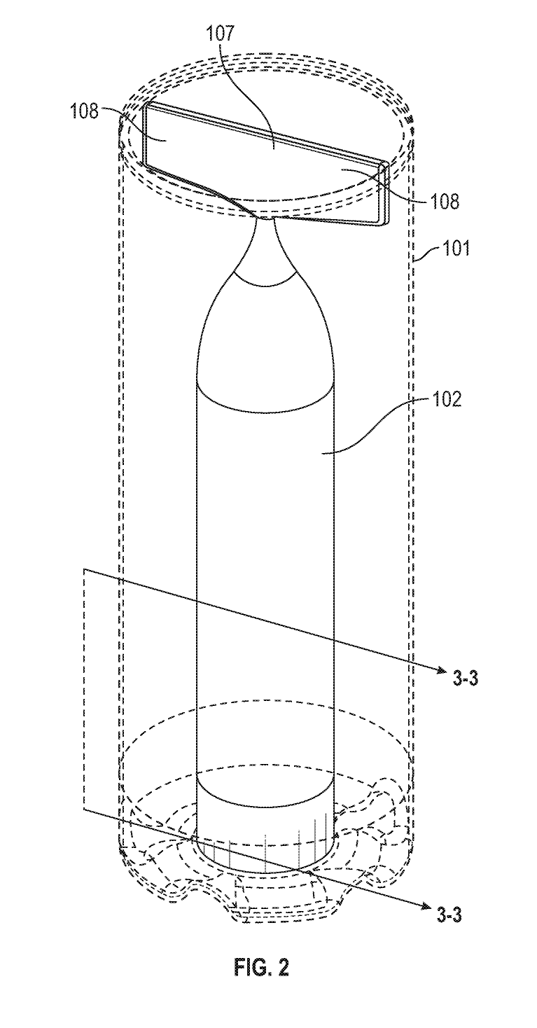

FIG. 2 illustrates another embodiment of the apparatus 100 and an additional stabilizing feature of the upshot 102. More specifically, the lateral members 108 of the upshot handle 107 may extend outward from the upshot 102 to a nominal distance from the interior walls of the host 101. This may assist with preventing prolapse of the upshot 102 when the host 101 is jostled or transported. In some embodiments, the lateral members 108 may abut the interior walls of the host 101. Other embodiments may leave a small space to allow the upshot 102 to be twisted and pulled from within the can without friction or disruption from the interior walls of the host 101. Furthermore, the upshot handle 107 may be structured to be positioned within the host 101 before the host taper 122 or after the host taper 122 as shown in FIG. 1. Additionally, the upshot 102 may include one straight end consisting solely of a truncated upshot handle 107 that does not include an upshot head 109.

Referring back to FIG. 1, another stabilizing feature of the upshot 102 within the host 101 may be the engagement between the upshot 102 and a plug 106 in the host bottom 105. The plug 106 may be a domed or enclosed protrusion extending distally from the host bottom 105 toward the host top 121. The plug 106 may include a plug base 130 and a plug top 131. In some embodiments, the plug 106 may be structured to be removably engaged with an aperture in the host bottom 105. However, in other embodiments, the plug 106 may be integrally formed with the host bottom 105.

In embodiments where the plug 106 is integrally formed with the host bottom 105, the plug 106 may include walls surrounding a void in the exterior of the host bottom 105. Therefore, the plug 106 may be convex when viewing it from the host top 121, but may be concave when viewing it from the host bottom 105.

The plug 106 may be dimensioned so that it may engage with and form a friction fit with at least one of the structure defining the upshot opening 112 and the upshot body 111 to form a fluidic seal therebetween. In some embodiments a circumference of interior walls of the upshot body 111 and circumference of the upshot opening 112 may be sized to friction fit with a base of the plug. Meaning, the upshot 102 may be removably positioned around the plug 106 to where the upshot opening 112 abuts the host bottom 105 and a portion of the upshot body 111 circumscribes the plug 106.

In some embodiments, the plug 106 may include an O-Ring gasket 127 around a perimeter thereof that may facilitate establishing the friction fit and fluidic seal between the plug 106 and the upshot 102. In some embodiments, the O-Ring gasket 127 may be located toward the plug top 131. The plug 106 may further comprise plug threading 116 that encircles the plug base 130. In such embodiments interior walls of the upshot body 111 proximate the upshot opening 112 may include upshot threading 132 to matingly engage the plug threading 116. The plug threading 116 may be male threading and the upshot threading 132 may be female threading or vice versa. In either case, the upshot opening 112 may be structured to engage with and form a friction fit overtop the O-Ring gasket 127. Additionally, the portion of the upshot body 111 containing upshot threading 132 may be structured to removably tighten with the plug threading 116. However, it is contemplated to be within the scope herein that the plug 106 may not include plug threading 116 or an O-Ring gasket 127 and may simply friction fit with the upshot opening 112 and a portion of the upshot body 111.

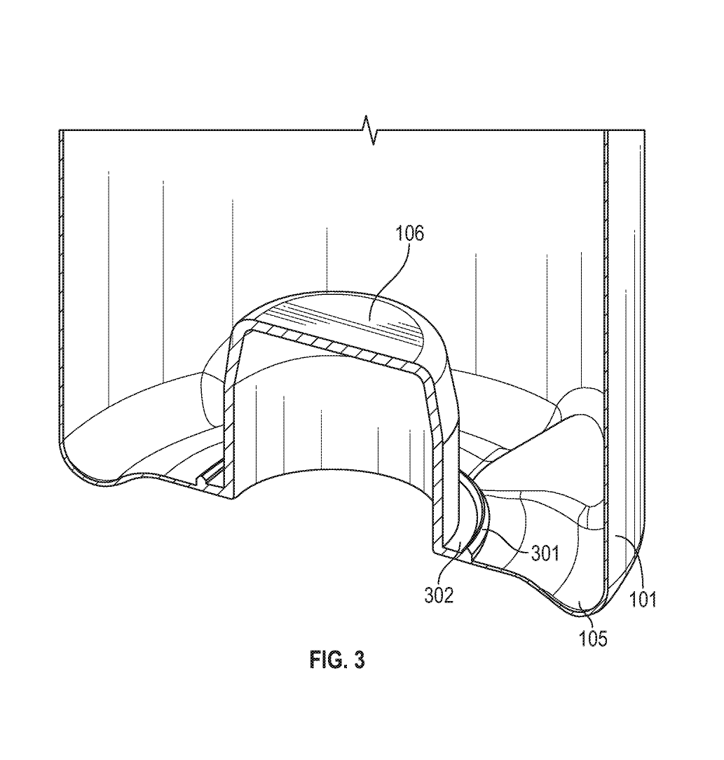

Referring additionally to FIG. 3, another stabilizing feature may include the host bottom 105 formed with a host ridge 301 encircling the plug 106 to form a bottom groove 302. The bottom groove 302 may be formed to engage an upshot lip 133 that may encircle the upshot opening 112. In this embodiment, the upshot lip 133 may engage with and form a friction fit within the bottom groove 302 of the host 101 to help removably secure the upshot 102 to the host 101.

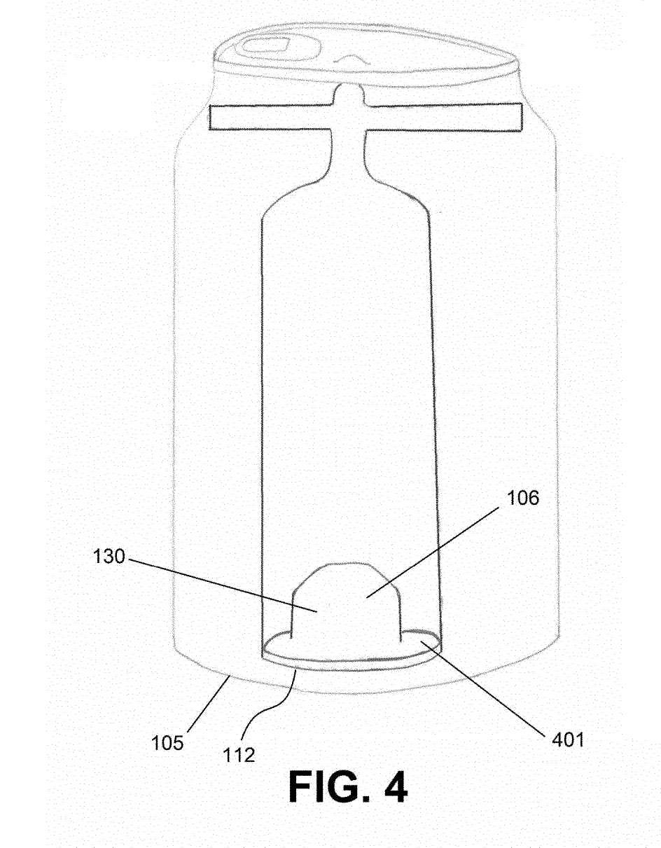

FIG. 4 illustrates another embodiment of the plug 106 that may be used to stabilize the upshot 102 within the host 101. In this embodiment, the plug base 130 may sit atop a plug platform 401. The plug platform 401 may include a circular protrusion atop the host bottom 105 extending distally therefrom. The plug platform 401 may be sized to friction fit with the upshot opening 112, which may be slightly larger in diameter than the plug platform 401. Also contemplated within this embodiment is an upshot lip 133 that may engage with and form a friction fit within a bottom groove of the host akin to the bottom groove 302 of FIG. 3 to help removably secure the upshot 102 to the host 101.

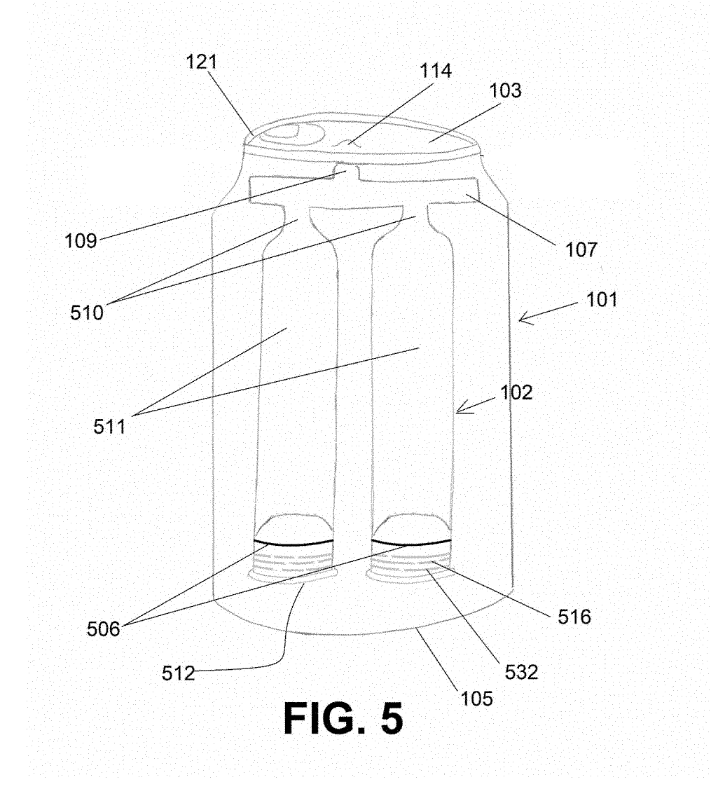

FIG. 5 illustrates another embodiment of the apparatus 100 whereby the upshot 102 may include a plurality of chambers. The host bottom 105 may include a plurality of plugs 506 and the upshot may include a plurality of upshot necks 510 a plurality of upshot bodies 511 and a plurality of upshot openings 512 whereby the upshot openings 512 may be structured to matingly engage the plurality of plugs 506 to form fluidic seals therebetween. The plurality of upshot bodies 511 may be structured to contain the same or differing amounts of matter. By way of non-limiting example, one upshot body 511 may be dimensioned to contain an ounce of liquid and another upshot body 511 may be dimensioned to contain two ounces of granulated matter, or vice versa. In this embodiment, the upshot handle 107 may remain largely the same as the other illustrated embodiments and may contain at least one planar surface that is operable as an advertising platform. Furthermore, the upshot handle 107 may include opposing ends configured to extend to a nominal distance between opposing ends and interior walls of the host.

The circumference of interior walls of the plurality of upshot bodies 511 and circumference of the plurality of upshot openings 512 may be sized to establish a friction fit with the plurality of plugs 506. Furthermore, in some embodiments the plurality of plugs 506 may include a plurality of gaskets 550 positioned thereon structured to form removeable seals between a portion of the plurality of upshot bodies 511 and the plurality of plugs 506. Similarly, some embodiments may include the plurality of plugs 506 including a plurality of plug threading 516 to engage with the plurality of upshot bodies 511 with a plurality of upshot threading 532. The plurality of plug threading 516 may be male threading and the plurality upshot threading 532 may be female threading or vice versa. In either case, the plurality of upshot openings 512 may be structured to friction fit overtop the plurality of gaskets 550 and the portions of the plurality of upshot bodies 511 containing upshot threading 532 may be structured to removably tighten with the plurality of plug threading 516. However, it is contemplated to be within the scope herein that the plurality of plugs 506 may not include the plurality of plug threading 516 or the plurality of gaskets 550 and may simply friction fit with the plurality of upshot openings 512 and a portion of the plurality of upshot bodies 511.

In some embodiments, the plurality of plugs 506 may taper at one end and the plurality of upshot bodies 511 may include a taper toward the plurality of upshot necks 510. Furthermore, the host lid 103 may include an upshot placeholder 114, configured to engage with the upshot head 109. In some embodiments, the upshot head 109 may be integrally formed with the upshot handle 107 and in other embodiments the upshot head 109 may be a removable stopper structured to removably engage an aperture within the upshot handle 107. In this embodiment, when the upshot head 109 is removed, the exposed aperture may be used to fill the upshot 102 with matter.

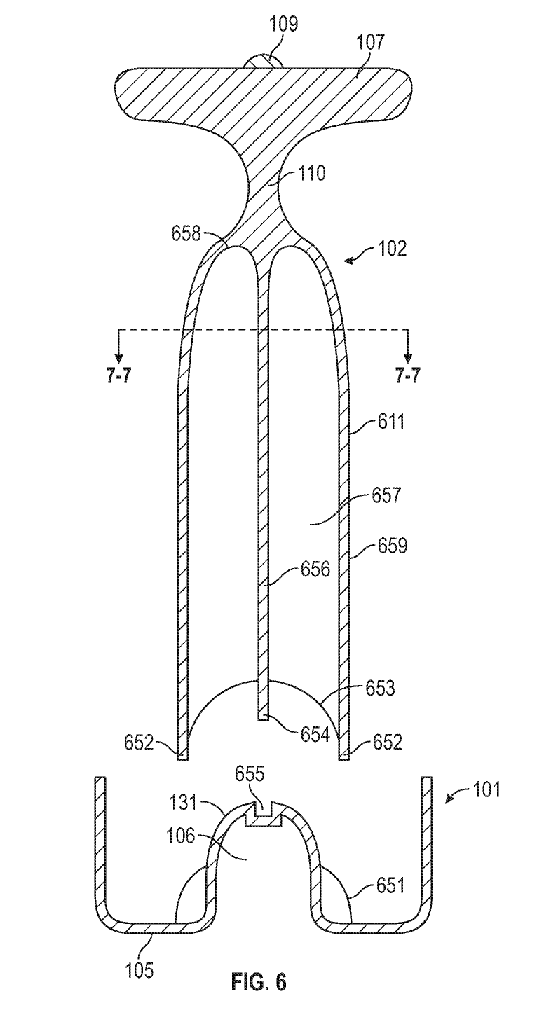

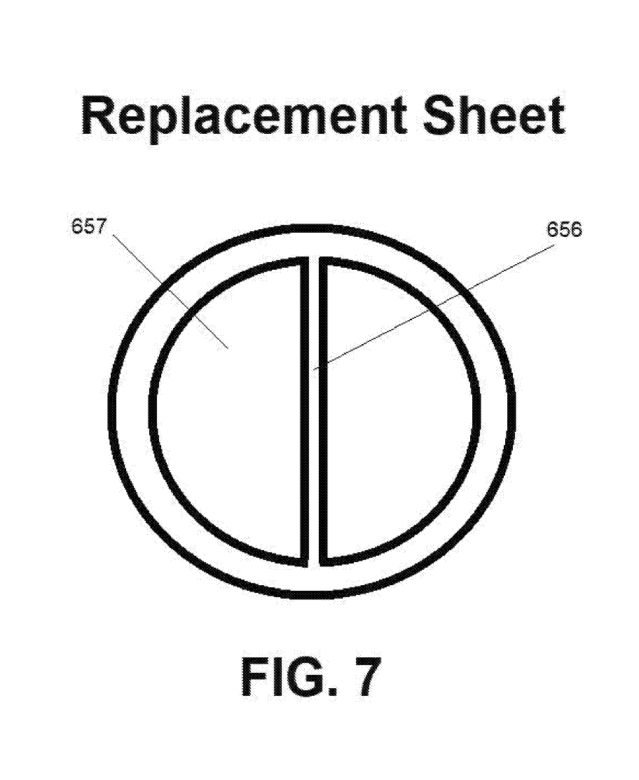

FIG. 6 illustrates another embodiment of the apparatus 100 whereby the upshot 102 may include a plurality of chambers 657 but only one upshot neck 110. In this embodiment, the upshot chambers 657 may be bifurcated by an upshot divider 656 as further illustrated in FIG. 7. The upshot chambers 657 may be generally tubular in shape with an enclosed curved end 658 and an arcuate upshot opening 653 at longitudinally opposite ends of the upshot body 611. In this embodiment, upshot body walls 659 that encircle the upshot body 611 may extend from the upshot neck 110 to the arcuate upshot opening 653. In some embodiments, the upshot 102 may be a monolithic unit with the upshot divider 656, upshot body 611, upshot neck 110 and upshot handle 107 formed from one piece of material. In other embodiments, the upshot 102 may be modular and the upshot chambers 657 may be separate tubular entities inserted into appropriately sized voids within the upshot body 611.

The upshot body walls 659 may extend to a length greater than the upshot divider 656 and may engage with and form a friction fit into a circular recess 651 around the plug 106 at peripheral connectors 652. In some embodiments, the peripheral connectors 652 may be a circular ridge or lip designed to fit securely within the circular recess 651 for stabilization of the upshot 102 within the host 101. The arcuate upshot opening 653 may be structured to encompass the plug 106 when the upshot 102 is fitted within the host 101. In some embodiments, the arcuate upshot opening 653 may abut the plug 106 in order to facilitate forming a fluidic seal between the two. In other embodiments, there may be a small space between the arcuate upshot opening 653 and the plug.

The upshot divider 656 may extend from one end of the upshot body 611 to the plug top 131 when the upshot is affixed within the host 101. The plug top 131 may include a plug notch 655 structured to removably engage an end of the upshot divider 656 defined as a medial plug connector 654. In this embodiment, when the upshot 102 is engaged within the host 101 the peripheral connectors 652 may be engaged with the circular recess 651 and the medial plug connector 654 may be engaged with the plug notch 655. Once engaged in this fashion, the upshot 102 is removably engaged with the host 101 and fluidically sealed to prevent premature mixing of contents from within the upshot 102 with contents from within the host 101. As in other embodiments, the upshot handle 107 may comprise an upshot head 109 used to stabilize with an upshot placeholder 114 that may or may not be removable. Furthermore the upshot handle 107 may include opposing ends structured to extend to a nominal distance between opposing ends and interior walls of the host 101.

Methods of assembling the apparatus 100 will now be discussed. In some embodiments the apparatus 100 may be assembled with the host lid 103 initially secured to the host top 121. The upshot 102 may then be placed into the host 101. In some embodiments the upshot placeholder 114 may serve as a spotter for placement of the upshot head 109 thereon. The host 101 may be inverted so that the intended contents of the host 101 and the upshot 102 may be filled. Once the host 101 and the upshot 102 have been filled, the host bottom 105 may be placed on the host 101 with the host plug 106 or plurality of plugs 506 fit securely into the upshot opening 112, plurality of upshot openings 512, or arcuate upshot openings 653 respectively. In some embodiments this may require the host bottom 105 to be rotated along with applied force in order to threadably engage the upshot 102. However, in other embodiments the host bottom 105 may be friction fit with force alone.

Another method of assembly may include the host bottom 105 already integrally formed with the host 101 whereby the host is 101 inverted. The upshot 102 may be filled with matter and the plug 106 or plurality of plugs 506 fit securely onto the upshot opening 112, plurality of upshot openings 512, or arcuate upshot openings 653 respectively. The host 101 would then be returned to an upright position for filling and the host lid 103 placed on the host top 121.

Another method of assembly may include the host bottom 105 initially secured to the host 101. In this embodiment the upshot 102 may then be placed within the host 101 with the upshot opening 112, plurality of upshot openings 512, or arcuate upshot openings 653 fitted onto the host plug 106 or plurality of plugs 506 respectively. In some embodiments this may require the upshot 102 to be rotated along with applied force in order to threadably engage the plug 106. However, in other embodiments the upshot 102 may be friction fit with force alone.

The contents of the host 101 may then be filled through the open host top 121. The contents of the upshot 102 may then be filled by removing the upshot head 109 and filling the upshot 102 with matter via an aperture within the upshot handle 107. However, in some embodiments the upshot 102 may be manufactured without an upshot head 109 in place and simply an exposed aperture within the upshot handle 107 structured to receive material therein. In either embodiment, the upshot 102 may be filled with matter through the aperture and the upshot head 109 may be placed within or overtop the aperture once filled. The host lid 103 may then be placed onto the host top 121 and secured thereto.

Methods of using the apparatus 100 will now be discussed. A user wishing to consume the contents of the apparatus 100 may open the apparatus at the host lid 103. In some embodiments this may involve a user pulling a pull tab 126 and removing the entire host lid 103 and exposing the entire host top 121. In other embodiments this may include removing a host lid 103 by pulling away a friction fit cap overtop the host body 104 and host top 121.

Once the entire host lid 103 has been removed and the entire host top 121 exposed, a user may find the upshot 102 within the host 101. The host 101 may be filled with a separate material than the upshot 102. By way of non-limiting example, the host 101 may be filled with soda and the upshot 102 may be filled with alcohol. In other embodiments the host 101 may be filled with a liquid and the upshot 102 may be filled with granular matter. Still in other embodiments the host 101 may be filled with one liquid and the upshot 102 may be filled with a variety of matter including granular matter and various liquids within a plurality of upshot bodies 511 or upshot chambers 657. In some embodiments, the upshot body 111 may hold two ounces of matter in one chamber and one-ounce of matter in another. In other embodiments they may hold one ounce of liquid and one ounce of granulated matter. Furthermore, it is contemplated herein that upshot bodies 111 and upshot chambers 657 may be a variety of sizes including one ounce, two-ounce, and three ounces to hold a respective amount of matter therein.

A user may either twist and pull the upshot 102 via the upshot handle 107 or simply pull the upshot 102 via the upshot handle 107 depending on the embodiment. As the user pulls the upshot 102 away from the plug 106, the contents from within the upshot 102 may be emptied into the host 101 thereby mixing the contents of the upshot 102 with the contents of the host 101. In some embodiments a user may use the upshot 102 as a stir to thoroughly mix the combined contents within the host 101. In other embodiments, simply removing the upshot 102 from the host will allow the contents therein to thoroughly mix with the contents of the host 101. In any embodiment, once the upshot 102 has been removed and its contents mixed with the host 101, the host 101 may become a drinking container for consuming the mixed drink.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the appended claims and their legal equivalents, and not by the examples given.

That which is claimed is:

1. A multi-chambered beverage container and mixing apparatus comprising:
an outer container defined as a host, comprising:
a host top;
a host lid;
a host body; and
a host bottom comprising a plug; and
an inner container defined as an upshot, comprising:
an upshot handle;
an upshot head;
an upshot body; and
an upshot opening;
wherein the upshot is positionable within an enclosed interior of the host body; and
wherein the upshot opening is configured to permit the plug to be positioned therethrough to engage with a wall of the upshot body and form a fluidic seal between the wall of the upshot body and the plug.

2. The multi-chambered beverage container and mixing apparatus of claim 1 wherein the host lid further comprises a recess, defined as an upshot placeholder, configured to engage with the upshot head.

3. The multi-chambered beverage container and mixing apparatus of claim 1 wherein a circumference of an interior wall of the upshot body and a circumference of the upshot opening are sized to establish a friction fit with a base of the plug.

4. The multi-chambered beverage container and mixing apparatus of claim 1 wherein an interior wall of the upshot body proximate the upshot opening comprises threading configured to matingly engage threading on the plug.

5. The multi-chambered beverage container and mixing apparatus of claim 1 wherein the host lid is configured to removeably engage with an interior of the host top.

6. The multi-chambered beverage container and mixing apparatus of claim 1 wherein the upshot body is tubular and sized to permit disposal therewithin of at least one of two-ounces of matter and one-ounce of matter; and wherein the matter is comprised of at least one of a liquid substance and a granular substance.

7. The multi-chambered beverage container and mixing apparatus of claim 1 wherein the upshot handle comprises at least one planar surface that is operable as an advertising platform.

8. The multi-chambered beverage container and mixing apparatus of claim 1 wherein the plug comprises an O-ring gasket; and wherein the upshot body is configured to establish a friction fit with the O-ring gasket.

9. A multi-chambered beverage container and mixing apparatus comprising:
an outer container, defined as a host comprising:
a body; and
a plug; and
an inner container, defined as an upshot comprising:
an upshot handle;
an upshot body comprising a plurality of upshot chambers formed from an upshot divider; and
an arcuate upshot opening;
wherein the upshot is located within an enclosed interior of the host body; and
wherein the arcuate upshot openings are configured to matingly engage a portion of the upshot body with the plug to form a fluidic seal between the upshot opening and the plug.

10. The multi-chambered beverage container and mixing apparatus of claim 9 wherein the plurality of upshot chambers is configured to contain at least one of an ounce of liquid and an ounce of granulated matter.

11. The multi-chambered beverage container and mixing apparatus of claim 9 wherein a host lid is configured to removeably engage with an interior of a host top.

12. The multi-chambered beverage container and mixing apparatus of claim 9 wherein the upshot handle comprises at least one planar surface that is operable as an advertising platform.

13. The multi-chambered beverage container and mixing apparatus of claim 9 wherein the upshot comprises at least two upshot chambers of the plurality of upshot chambers; and wherein the at least two upshot chambers are differently sized and configured to hold a different amount of matter in each.

14. The multi-chambered beverage container and mixing apparatus of claim 9 wherein the upshot divider is configured to removably engage a plug notch.

15. The multi-chambered beverage container and mixing apparatus of claim 9 wherein an upshot body wall is configured to removably engage a circular recess in a host bottom.

16. The multi-chambered beverage container and mixing apparatus of claim 9 wherein plurality of chambers is tubular.

17. The multi-chambered beverage container and mixing apparatus of claim 9 wherein the upshot handle comprises opposing ends configured to extend to a nominal distance between opposing ends and interior walls of the host.

18. The multi-chambered beverage container and mixing apparatus of claim 9 further comprising a host lid comprising a recess, defined as an upshot placeholder, configured to engage with an upshot head located on the upshot handle.

19. The multi-chambered beverage container and mixing apparatus of claim 18 wherein the upshot head is configured to removably engage an aperture within the upshot handle.

20. A multi-chambered beverage container and mixing apparatus comprising:
an outer container, defined as a host, comprising:
a host top;
a host lid;
a host body; and
a host bottom comprising a plurality of plugs; and
an inner container, defined as an upshot, comprising:
an upshot handle;
an upshot head;
a plurality of upshot necks;
a plurality of upshot bodies; and
a plurality of upshot openings;
wherein the upshot is positionable within an enclosed interior of the host body; and
wherein the upshot openings are configured to matingly engage a portion of the plurality of upshot bodies with a plurality of plugs to form fluidic seals therebetween.
